(19) United States
(12) Patent Application Publication
(10) Pub. No.: US 2014/0017581 A1
(43) Pub. Date: Jan. 16, 2014

(54) COMPACT FUEL CELL

(71) Applicants: Delphine Drouhault, Barberaz (FR); Pierre Nivelon, Saint Hilaire Du Touvet (FR)

(72) Inventors: Delphine Drouhault, Barberaz (FR); Pierre Nivelon, Saint Hilaire Du Touvet (FR)

(73) Assignee: Commissariat A L'Energie Atomique Et Aux Ene ALt, Paris (FR)

(21) Appl. No.: 14/009,446

(22) PCT Filed: Apr. 3, 2012
(86) PCT No.: PCT/EP2012/056085

§ 371 Date: Oct. 2, 2013

(30) Foreign Application Priority Data
Apr. 5, 2011 (FR) 1152932

(51) Int. Cl. H01M 8/04

(52) U.S. Cl. CPC H01M 8/04134
USPC 429/413

(57) ABSTRACT

A fuel cell including a stack of electrochemical cells and first and second end plates, an inside circuit for flowing deionized water inside the stack connected to an outside circuit for flowing deionized water outside the stack, the deionized water forming a coolant, a circuit for supplying hydrogen to the cells and a circuit for supplying air to the cells, and a casing mounted to the first end plate and forming a tight volume at least partially filled with water where the inside circuit emerges for flowing the coolant. The circuits for supplying air and hydrogen pass through the tight volume and are dipped into the deionized water to exchange heat with the deionized water. A portion of the supply circuit enables air to be humidified with water contained in the tight volume.

### TECHNICAL FIELD AND PRIOR ART

The present invention relates to a compact fuel cell.

A fuel cell, to deliver electricity, is supplied with fuel gas, for example hydrogen in the case of a proton exchange membrane fuel cell (PEMFC), and with oxidizing gas, for example air or oxygen. The operation of the fuel cell also results in generating heat energy.

A fuel cell comprises a stack of electrochemical cells, each cell comprising an anode and a cathode. The cells are kept compressed against each other by end plates connected by the tie rods

A circuit is provided to supply reactive gases to the cells. Those reactive gases should be brought to the fuel cell under preset temperature, pressure and moisture conditions. The fuel cell therefore comprises devices for controlling pressure, temperature and moisture of the oxidizing gas and devices for controlling pressure, temperature of the fuel gas. Generally, the moisture content of the oxidizing gas is controlled by an air-air type exchanger. A heating device is provided to heat hydrogen before it enters into the cells.

On the other hand, the electrochemical efficiency of the fuel cell is dependent on the temperature within the fuel cell because of the very nature of the materials used. Consequently, this temperature should be monitored in order to obtain the highest possible efficiency. Indeed, if the operating temperature is too low, the best operating efficiency of the fuel cell could not be achieved, and if the fuel cell undergoes a too high temperature rise, the materials making up the fuel cell can be damaged. The optimum temperature range is from 65° C. to 75° C.

As explained previously, the fuel cell generates heat during operation thereof. This heat should generally be removed to restrict the temperature rise within the fuel cell. For that purpose, a flow of a coolant inside the cells is generally provided, wherein the coolant flow rate and temperature are controlled.

Further, by flowing into the fuel cell, the coolant is directly in contact with bipolar plates, the electrical conductivity of the coolant is then monitored to remain lower than some threshold in order to preserve the electrical efficiency of the fuel cell. For this, the electrical conductivity of the coolant is restricted to a sufficiently low value. For example, deionized water is used as the coolant. In order to restrict the electrical conductivity thereof, resins for regenerating deionized water are provided in the cooling circuit. It should be noted that the maximum operating temperature of the regenerating resins is in the order of 50° C.

These different elements are provided in the periphery of the stack of cells and are connected to each other and to the same by conducts and valves. The overall space of the fuel cells is thus very high.

However, it is reminded that this type of fuel cell is particularly intended to be on board vehicles as the drive power source. Consequently, its overall space is a crucial point.

### DISCLOSURE OF THE INVENTION

It is therefore an object of the present invention to provide a fuel cell equipped with a fluid management system having an overall space reduced as compared with assemblies of the state of the art.

The object set forth above is achieved by a fuel cell comprising a stack of cells provided between two end plates rigidly connected to each other and comprising a casing secured to one of the end plates wherein are accommodated the humidifying device and the heating device, said casing being directly connected to the cooling circuit at the outlet of the cells, the humidifying device and the heating device then being submerged in the coolant; the humidifier being a water-air humidifier and the heating device using heat removed by the coolant from the fuel cell.

In other words, the coolant used as a means for humidifying and heating reactive gases, it fills a tank directly provided on one of the end plates wherein emerges the cooling circuit after passing through the cell stack. The number of distinct devices and, hence, the connections and length thereof are reduced. The overall space is therefore decreased.

Advantageously, an ion exchange device is also provided on the end plate as close as possible to the casing with which it is connected to deionize the coolant flowing out of the cells.

For example, the ion exchange device is formed by ion exchange resins. Advantageously, a thermostatic valve is provided between the casing and the ion exchange device to allow flow in the ion exchange device only when the coolant temperature is lower than the threshold temperature.

The subject-matter of the present invention is therefore a fuel cell comprising a stack of electrochemical cells and a first and second end plates applying a tightening strain to the electrochemical cells, a heat management system formed by a circuit for flowing a coolant inside the stack and a circuit for flowing the coolant outside the stack, a circuit for supplying fuel gas to the cells and a circuit for supplying an oxidizing gas to the cells, means for heating the fuel and oxidizing gases before they are injected into the cells and means for humidifying the oxidizing gas before it is injected into the cells, wherein the fuel cell comprises a so-called main casing, mounted to the first end plate and forming a tight volume downstream of the inside circuit for flowing the coolant in the stack and wherein emerges the inside circuit for flowing the coolant, said volume being intended to be at least partially filled with the coolant flowing out of the stack, wherein the circuit s for supplying the oxidizing gas and fuel gas pass through the tight volume and are intended to be dipped into the coolant so as to exchange heat with the same and wherein at least one portion of the circuit for supplying the oxidizing gas intended to be dipped into the coolant is able to allow water contained in the coolant to be transferred from outside of the circuit for supplying the oxidizing gas to the inside of said circuit in order to humidify the oxidizing gas.

Preferably, the circuit for supplying oxidizing gas comprises a proton conductor ionomer portion, for example of Nafion®, to enable water to pass into said portion.

At least one portion of the circuit for supplying fuel gas intended to be dipped into the coolant advantageously has a material exhibiting a good thermal conductivity, for example is of stainless steel.

The circuit for supplying fuel gas can also comprise a proton conductor ionomer portion, for example of Nafion®, to enable water to pass into said portion.

Preferably, the portions of the circuit s for supplying fuel gas and oxidizing gas intended to be dipped into the coolant comprise a parallel connected tube bundle in order to enhance exchanges with the coolant.

The tight volume can be partially filled in order to provide for an expansion vessel.

The fuel cell preferably comprises means for decreasing the electrical conductivity of the coolant.

The fuel cell can thus comprise an additional casing mounted to said first end plate in the vicinity of the main casing, wherein are provided the means for decreasing the electrical conductivity, the means for decreasing the electrical conductivity being connected to the inner volume so as to enable the coolant to flow into the means for decreasing the electrical conductivity.

For example, the means for decreasing the electrical conductivity are formed by regenerating resins, the fuel cell then comprises a valve controlling the flow of the coolant between the main casing and the regenerating resins in dependence on the coolant temperature, the valve disrupting the communication for a temperature higher than about 50° C. The valve is advantageously a thermostatic valve.

The fuel cell also advantageously comprises means for heating the coolant which are provided in the main casing, for example formed by an electrical resistor.

The outside circuit can comprise a first sub-circuit provided with a heat exchanger and a second sub-circuit directly connected to the inlet of the inside circuit m, a device for controlling the flow of the coolant in either or both sub-circuits in dependence of the temperature of said coolant at the outlet of the inside circuit.

Preferably, the control device is a three-way thermostatic valve.

Advantageously, the control device is integrated between the main casing and the additional casing such that the additional casing is part of the second subcircuit.

Besides, in a very advantageous embodiment, the fuel cell only comprises two outlets for the coolant, one outlet formed in a wall of the main casing towards the first sub-circuit and one outlet in a wall of the additional casing towards the second sub-circuit.

The main casing can comprise means for measuring the temperature of the coolant and/or means for measuring the electrical conductivity of the coolant and/or means for monitoring the coolant filling level of the tight volume.

The main casing can comprise for example in an upper area a filling port sealed by a cap, advantageously a vent and/or a pressure relief valve.

The fuel gas supply and the oxidizing gas supply for the cells are made, for example, through the first end plate by means of the pipes between the fuel gas supply circuit and the oxidizing gas supply circuit and a side face of the first end plate.

The coolant is advantageously deionized water.

The fuel cell is for example of the proton exchange membrane type, the fuel gas is hydrogen and the oxidizing gas is oxygen.

### BRIEF DESCRIPTION OF THE DRAWINGS

The present invention will be better understood using the following description and the appended drawings wherein:

FIG. 1A is a schematic representation of an exemplary embodiment of a fuel cell according to the present invention,

FIG. 1B is a cross-section view of FIG. 1A along plane A-A,

FIG. 2 is a perspective view of an exemplary embodiment of a fuel cell according to the present invention,

FIG. 3 is an enlarged view of a detail of FIG. 2,

FIG. 4 is a perspective view of an opposite face of the fuel cell of FIG. 3,

FIG. 5 is a top view of the fuel cell of FIG. 2.

### DETAILED DESCRIPTION OF PARTICULAR EMBODIMENTS

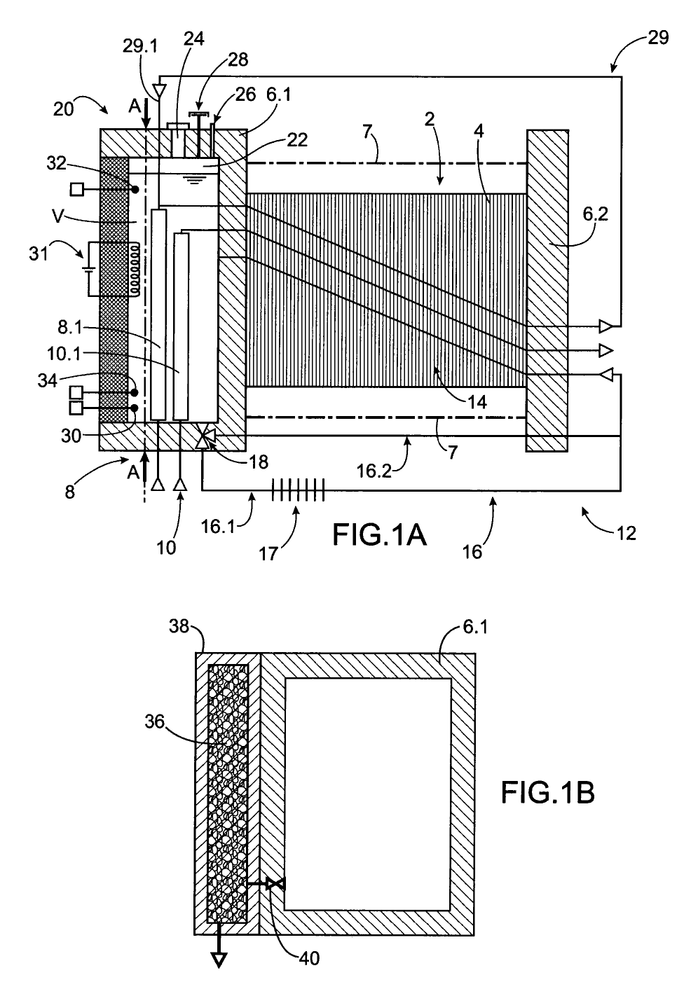

In FIG. 1A, a schematic representation of an exemplary embodiment of a fuel cell according to the present invention can be seen.

In the description that follows, a proton exchange membrane fuel cell or Polymer Exchange Membrane Fuel Cell (PEMFC) will be described in particular. The fuel gas is then hydrogen and the oxidizing gas is air or oxygen. However, this description is in no way limiting and the invention is applicable to any type of fuel cell.

The fuel cell comprises a stack 2 of electrochemical cells 4 consisting of bipolar plates and ion exchange membranes alternately provided, and two end plates 6.1, 6.2 on either side of the stack. The end plates 6.1, 6.2 are connected by tie rods 7 and exert a compressive strain to the stack 2 to ensure an evenly distributed electrical conduction throughout the surface of the elements making up the cells.

The fuel cell comprises a circuit 8 for supplying hydrogen to the cells and a circuit 10 for supplying air or oxygen to the cells. For the sake of simplicity, only air will be mentioned as the oxidizing gas.

The supply circuits 8 and 10 pass directly through the cells to supply them.

The fuel cell also comprises a thermal management system 12 formed by a circuit 14 for flowing a coolant within the stack in order to exchange heat with the cells, and a flow circuit 16 provided outside the stack. The coolant used can be deionized water.

The outside flow circuit 16 comprises two sub-circuits 16.1, 16.2, one 16.1 is intended to extract heat built up upon passing through the stack before reinjecting the coolant into the stack via the inside circuit 14 and is equipped with a heat exchanger 17 to that end; the other sub-circuit 16.2 is intended to directly reinject the coolant flowing out the stack into the inside flow circuit 14. Means 18 for selecting the flow in either sub-circuit 16.1, 16.2 are provided upstream, it is advantageously a three-way thermostatic valve which determines the coolant flow in either sub-circuit in dependence of the coolant temperature at the outlet of the stack. A flow pump (not shown) is provided in the outside circuit 16 to ensure the coolant flow into the stack.

The fuel cell comprises a so-called main casing 20, mounted to one 6.1 of the end plates, bounding a tight volume V wherein emerges a downstream end of the inside circuit 14 of the heat exchange circuit. This casing 20 is, in regular operation, at least partially filled with coolant.

The connection between the inside circuit 14 and the outside circuit 16 is made through one of the walls of the main casing 20, then the three-way thermostatic valve 18 is mounted in the wall.

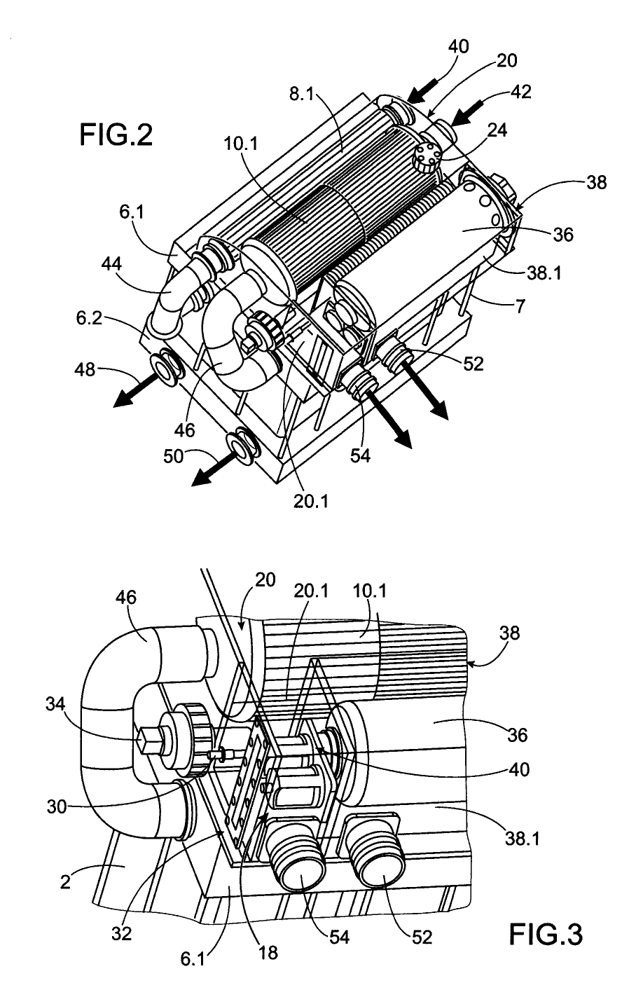

The circuit 9 for supplying hydrogen passes through the tight volume V so as to be submerged in the coolant. Part 8.1 of the supply circuit 8 located in the casing is located upstream of the stack, in the coolant flow direction, and is such that it facilitates heat exchanges between the coolant and hydrogen, in order to heat up hydrogen before it is injected into the cells. Preferably, this part 8.1 is formed by a parallel connected tube bundle, as can be seen in FIG. 2 or FIG. 5. Preferably, the tubes are made of a material having a good thermal conductivity, for example of stainless steel, for example of 316L stainless steel the production cost of which is reduced and being readily applicable.

Alternatively, in a case where humidification of hydrogen, and more generally of fuel gas is searched for, it can be contemplated to make these tubes of a material enabling water to pass inside the tubes, for example of proton conductor ionomer, for example of Nafion®. It can be contemplated that some tubes of the bundle are of stainless steel and other are of Nafion®. Alternatively, tubes of polymers having sulfonated poly(styrene-co-butadiene) chains can for example be used.

The circuit 10 for supplying air also passes through the tight volume V so as to be submerged into the coolant. Part 10.1 of the supply circuit 10 located in the casing is upstream the stack and is such that it ensures both air heating and air humidification from the coolant before it is injected into the cells. For example, part 10.1 of the circuit is also of proton conductor ionomer, of the Nafion® type. Advantageously, part 10.1 is also formed by a tube bundle increasing the exchange area. The moister gradient ensures the water transfer from outside the tubes to inside where air flows. The transferred vapour then enables air to be humidified.

Simultaneously to air humidification, an increase in temperature occurs.

Advantageously, the volume V of the casing is such that it also forms an expansion vessel 22 by only partially filling the volume V with coolant. This is schematically shown by the part of the volume left free of coolant in FIG. 1A.

In top part of the casing, this also comprises a port 24 for filling the heat exchange circuit that can be sealed by a cap.

A sealable vent 26 of the heat exchange circuit can also be provided, enabling to best flush air from the circuit upon filling, in order to optimize the exchange area between the bipolar plates of the fuel cell and the cooling liquid. Safe means 28 can also be provided in case of a rise in pressure in the heat exchange circuit, for example formed by a valve. It can be contemplated that the valve is formed in the cap of the filling port.

Advantageously, the hydrogen amount injected in the cells is higher than that required to increase the electrolysis reaction yield. Unconsumed hydrogen at the outlet of the circuit 8 is reinjected into the circuit. The fuel cell therefore advantageously comprises a circuit 29 for reinjecting hydrogen into the stack, this is for example connected to the circuit 8 at the outlet of part 8.1 of the circuit for supplying hydrogen. Indeed, since reinjected hydrogen flows out from the fuel cell, it is not necessary to warm it and it can be directly reinjected. However, it can be contemplated to connect the reinjection circuit upstream of part 8.1 of the circuit for supplying hydrogen.

In the example represented, the main casing 20 comprises a recirculation tap 29.1 to connect the recirculation circuit 29 to the supply circuit 8.

Advantageously, cold warming means 31 are provided in the casing for warming the coolant and simultaneously hydrogen and air at the beginning of the fuel cell operation as long as the coolant has not been warmed by the heat emitted by the cells. It is for example resistor type electrical means soaked in the coolant or else fluid means with a heat exchange circuit. For example, the cold warming means 31 are activated for a temperature lower than 5° C.

Preferably, the fuel cell comprises means for monitoring the fuel cell operation. It is for example means 30 for measuring the coolant temperature in the casing, means 32 for monitoring the coolant level in the casing to detect, for example, a leak and avoid a fuel cell overheating.

Further, since the coolant is directly in contact with the bipolar plates, preferably the electrical conductivity thereof is monitored, in order for this not to exceed a given threshold so as to preserve the electrical efficiency of the fuel cell. In this case, the fuel cell can also comprise means 34 for measuring the electrical conductivity of the coolant, for example provided in the casing and means for reducing this conductivity if so required which are formed by an ion exchange device 36, also called regenerating device.

The regenerating device 36 is schematically shown in FIG. 1B, it is provided sideways with respect to the main casing.

In the example represented and advantageously, this device 36 is accommodated in an additional casing 38 provided adjacent to the main casing 20 and connected to the same directly through the adjacent walls, which avoids to resort to a pipe.

The additional casing 38 is connected to the heat management system to reinject the coolant into the circuit after it has been regenerated.

Preferably, at each start-up of the fuel cell, the coolant liquid is automatically regenerated as long as the liquid temperature is lower than 50° C. The measurement of the liquid electrical conductivity can be used as a safeguard to advise to switch off the fuel cell or inform of worsened performance of the same. In a case of strong worsening in conductivity, it can be contemplated to switch the flow pump on without operating the fuel cell, to circulate the liquid into the regenerating resins for a time long enough to properly regenerate the coolant.

The ion exchange device 36 is for example formed by regenerating resins. The flow between the main casing 20 and the additional casing 38 is controlled in temperature for the coolant contacting the resins to be at a temperature higher than a temperature in the order of 50° C., that is the maximum operating temperature for the resins. Advantageously, this is a thermostatic valve 40 exhibiting a simple operation and a robust structure. However, a solenoid valve controlled by temperature measuring means 30 does not depart from the scope of the present invention.

Alternatively, the conductivity measurement could be made at the inlet of the stack and the regenerating device would be located on the second end plate 6.2.

In FIGS. 2 to 5 which represent a practical exemplary embodiment of a fuel cell according to the present invention wherein the compactness of the arrangement is particularly important, there can be seen the main casing 20 mounted to the end plate 6.1 and the additional casing 38 attached to the end plate 6.1 adjacent to the main casing 20. In the example represented, the additional casing 38 is shorter than the main casing 20, the main casing 20 then comprises advantageously a lateral extension 20.1 bordering a longitudinal end of the additional casing 38 and by which connections between both casings 20, 38 and with outside are provided.

Portion 8.1 of the circuit for supplying hydrogen and portion 10.1 of the circuit for supplying air are provided parallel in the main casing 20. Each of the portions is supplied by a longitudinal end symbolized by arrows 40, 42 for hydrogen and air respectively and is connected at the outlet to the cells by pipes 44, 46 which are connected to an edge of the end plate 6.2, the connection with the cells being made through the end plate.

Alternatively, the pipes 44, 46 could be removed, and the connections between portion 8.1 of the circuit for supplying hydrogen and the cells and between portion 10.1 of the circuit for supplying air and the cells would be made directly through the plate 6.1 in the bottom of the main casing 20.

The second end plate 6.2 comprises hydrogen and air outlets 48, 50 respectively.

The hydrogen outlet 48 is connected to the recirculation circuit 29.

The main casing 20 is connected to the regenerating device 36 via a two-way valve 40 located at the extension 20.2 controlled in temperature, the control temperature being the maximum temperature withstandable by the regenerating resins, i.e. about 50° C. Preferably, the two-way valve 40 is a thermostatic valve. The valve 40 ensures communication between the main tank and the regenerating device 36 when the coolant temperature is lower than 50° C. and disrupts it when the coolant temperature exceeds 50° C.

The main casing is further advantageously connected to the additional casing 38 by the “cold coolant” outlet of the three-way valve. The casing 38 then forms a portion of the sub-circuit 16.2.

The connection 22 of the additional casing 38 to the heat management system is located in a side face 38.1 of the additional casing 38.

The connection 54 provided with the three-way thermostatic valve 18 of the main casing 20 to the sub-circuits 16.1 and 16.2 is located in the extension 20.1.

Three flow modes will now be explained:

For temperatures lower than 50° C.: the thermostatic valve 40 is opened, the coolant flows from the main tank into the regenerating device, passes through the resins and leaves from the regenerating device into the additional tank 38. The additional tank is filled with coolant and the latter then flows out of the casing 38 by the tap 52 and directly goes back to the flow pump to recirculate in the cell stack, without passing through the heat exchange sub-circuit 16.1.

For temperatures between 50° C. and 70° C.: the two-way thermostatic valve 40 is closed and prevents the coolant from passing through the closed regenerating device 36. The three-way thermostatic valve is opened towards the additional tank 38, the coolant floods the additional casing 38 to leave from the tap 52 and directly goes back to the flow pump to recirculate in the cell stack, without passing through the heat exchanger of the sub-circuit 16.1.

For temperatures higher than 70° C.: the three-way thermostatic valve 18 is partially or fully opened toward the tap 54 leading to the sub-circuit 16.1, the coolant flows in the sub-circuit 16.1 and ensures cooling of the coolant via the heat exchanger 17.

Very advantageously, this connection architecture only uses a single tap 52 towards the sub-circuit 16.2. The manufacture of the fuel cell is thus simplified and leak risks are reduced.

Casings 20 and 38 can comprise a bottom which will press the end plate 6.1. Alternatively, the end plate forms the bottom of either or both casings 20 and 38. Tightness is thus made between the sidewalls of the casings and the end plate 6.1 for example by means of flat gaskets or O-rings.

The main casing 20 and the additional casing 38 can be integrally made.

An exemplary sizing of a fuel cell having a power 90 kW such as represented in FIGS. 2 to 5 for a hydrogen flow rate 60 Nm³/h and an air flow rate 300 Nm³/h will now be given by way of illustration.

The width W of the fuel cell is 630 mm (FIG. 5).

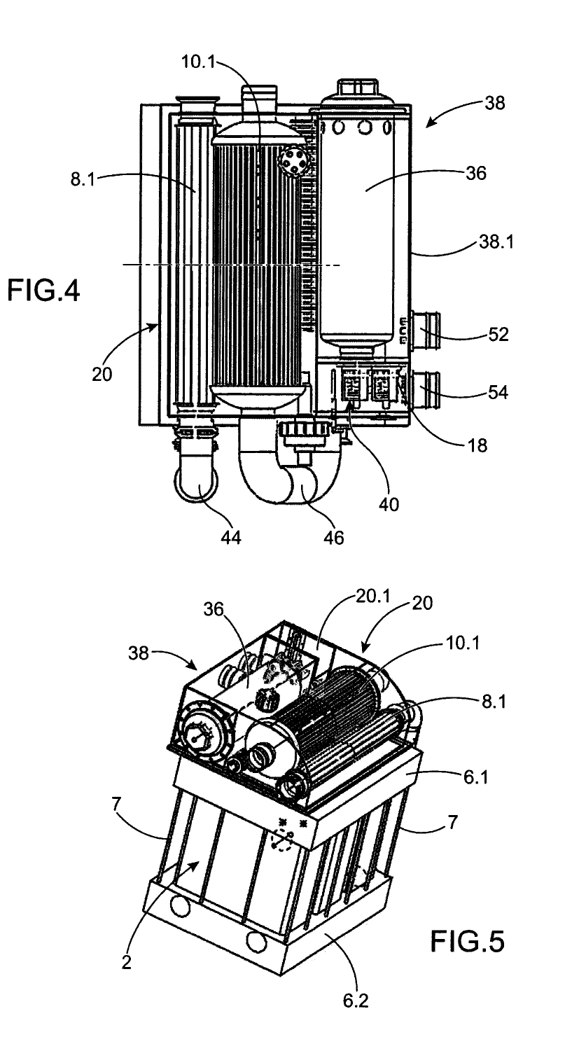

The height h of the casing is 200 mm and the depth d of the casing is 420 mm (FIG. 4). The total height of the fuel cell is in the order of 600 mm.

In comparison, a fuel cell system of the state of the art has a total height of 960 mm, a depth of 600 mm and a width of 710 mm.

A high decrease in the overall space can thus be observed by virtue of the present invention.

By virtue of the present invention, a very high volume gain is achieved to provide the humidification function, in the order of 100 litres, and a notable gain to ensure the warming function, in the order of 10 litres.

Further, since the number and the volume of pipes are reduced, the accessibility to different elements of the fuel cell is facilitated.

The fuel cell operation according to the present invention will now be explained.

When the fuel cell is started, the coolant is cold and cannot thus warm hydrogen and air. The cold start heating means are started up, for example, when the temperature is lower than 5° C.

The warmed and possibly humidified hydrogen and warmed and humidified air are injected into the cells. Simultaneously, the coolant, also warmed, flows in the stack. Electrochemical reactions occur in each of the cells.

The coolant extracts the heat emitted by the cells. When the coolant is hot enough to warm hydrogen and air, the cold warming means are switched off. The warming time is in the order of a few minutes in dependence on the electrical power to be provided by the fuel cell system. This warming time is all the more rapid if the circuits are short and thus the volumes to be warmed are low.

The hydrogen that flows out of the cells is reinjected into the circuit.

The coolant, as long as its temperature is lower than 50° C., is directly returned to the inlet of the inside circuit 14, via the regenerating device 36 and the additional tank 38.

When the temperature is between 50° C. and 70° C., the coolant is directly returned to the inlet of the inside circuit 14, via the additional tank 38 without passing through the regenerating device 36.

When its temperature exceeds 70° C., the three-way thermostatic valve 18 reacts and changes its configuration to lead the coolant to the outside sub-circuit 16.1, without passing through the additional tank 38, provided with the heat exchanger in order to decrease its temperature. The coolant thus cooled is reinjected at the inlet of the inside circuit 14.

The use of thermostatic valves allows for an autonomous management of the coolant flows in dependence of the coolant temperature.

Further, its electrical conductivity is measured, when it exceeds the given threshold, it is led into the regenerating device 36 if the liquid temperature is lower than 50° C. and is then reinjected into the heat exchange circuit. Otherwise, the conductivity measurement determines whether the fuel cell is operated under degraded conditions and a choice is made as to switch off the system or not.

The fuel cell according to the present invention is particularly adapted to on-board applications such as for example in automotive vehicles as a power source for powering drive electrical motors or for applications searching for mobile power sources, such as for example camping, military campaigns . . . .

1-19. (canceled)

20. A fuel cell comprising:
a stack of electrochemical cells and first and second end plates applying a tightening strain on the electrochemical cells;
a heat management system including an inside circuit for flowing a coolant inside the stack and an outside circuit for flowing the coolant outside the stack, a circuit for supplying fuel gas to the cells and a circuit for supplying an oxidizing gas to the cells, a heater for heating the fuel and oxidizing gases before they are injected into the cells, and a humidifier for humidifying the oxidizing gas before it is injected into the cells;
a main casing, mounted to the first end plate and forming a tight volume downstream of the inside circuit for flowing the coolant inside the stack and wherein emerges the inside circuit for flowing the coolant, the volume being configured to be at least partially filled with the coolant flowing outside the stack;
wherein the circuits for supplying the oxidizing gas and fuel gas pass through the tight volume and are configured to be dipped into the coolant to exchange heat with the coolant; and
wherein at least one portion of the circuit for supplying the oxidizing gas configured to be dipped into the coolant is configured to allow water contained in the coolant to be transferred from outside of the circuit for supplying the oxidizing gas to the inside of the circuit to humidify the oxidizing gas.

21. The fuel cell according to claim 20, wherein the circuit for supplying oxidizing gas comprises a proton conductor ionomer portion to enable water to pass into the at least one portion.

22. The fuel cell according to claim 20, wherein at least one portion of the circuit for supplying the fuel gas to be dipped into the coolant has a material exhibiting a good thermal conductivity, or is of stainless steel.

23. The fuel cell according to claim 22, wherein the circuit for supplying the fuel gas comprises a proton conductor ionomer portion to enable water to pass into the at least one portion.

24. The fuel cell according to claim 20, wherein portions of the circuits for supplying fuel gas and oxidizing gas to be dipped into the coolant comprise a parallel connected tube bundle to enhance exchanges with the coolant.

25. The fuel cell according to claim 20, wherein the tight volume is configured to be partially filled to provide for an expansion vessel.

26. The fuel cell according to claim 20, further comprising a device for decreasing electrical conductivity of the coolant.

27. The fuel cell according to claim 26, further comprising an additional casing mounted to the first end plate in a vicinity of the main casing, wherein is provided the device for decreasing the electrical conductivity, the device for decreasing the electrical conductivity being connected to an inner volume to enable the coolant to flow into the device for decreasing the electrical conductivity.

28. The fuel cell according to claim 27, wherein the device for decreasing the electrical conductivity includes regenerating resins, and a valve controlling flow of the coolant between the main casing and the regenerating resins in dependence on the coolant temperature, the valve disrupting communication for a temperature higher than about 50° C., the valve being a thermostatic valve.

29. The fuel cell according to claim 20, further comprising a heater for heating the coolant, the heater provided in the main casing.

30. The fuel cell according to claim 20, wherein the outside circuit comprises a first sub-circuit including a heat exchanger and a second sub-circuit directly connected to an inlet of the inside circuit, and a device for controlling flow of the coolant in either or both sub-circuits in dependence of temperature of the coolant at an outlet of the inside circuit.

31. The fuel cell according to claim 30, wherein the control device is a three-way thermostatic valve.

32. The fuel cell according to claim 30, wherein the control device is integrated between the main casing and an additional casing such that the additional casing is part of the second sub-circuit.

33. The fuel cell according to claim 31, wherein the control device is integrated between the main casing and an additional casing such that the additional casing is part of the second sub-circuit.

34. The fuel cell according to claim 32, only comprising first and second outlets for the coolant, the first outlet formed in a wall of the main casing towards the first sub-circuit and the second outlet in a wall of the additional casing towards the second sub-circuit.

35. The fuel cell according to claim 33, only comprising first and second outlets for the coolant, the first outlet formed in a wall of the main casing towards the first sub-circuit and the second outlet in a wall of the additional casing towards the second sub-circuit.

36. The fuel cell according to claim 20, wherein the main casing comprises a device for measuring temperature of the coolant and/or a device for measuring electrical conductivity of the coolant and/or a device for monitoring a coolant filling level of the tight volume.

37. The fuel cell according to claim 20, wherein the main casing comprises in an upper area a filling port sealed by a cap, or a vent and/or a pressure relief valve.

38. The fuel cell according to claim 20, wherein the fuel gas supply and the oxidizing gas supply for the cells are made through the first end plate by pipes between the fuel gas supply circuit and the oxidizing gas supply circuit and a side face of the first end plate.

39. The fuel cell according to claim 20, wherein the coolant is deionized water.

40. The fuel cell according to claim 20, wherein the fuel cell is of proton exchange membrane type, the fuel gas is hydrogen, and the oxidizing gas is oxygen.

41. The fuel cell according to claim 29, wherein the heater includes an electrical resistor.
